(19) United States
(12) Patent Application Publication
(10) Pub. No.: US 2016/0150838 A1
(43) Pub. Date: Jun. 2, 2016

(54) Le Side Slide Pocket

(71) Applicant: Vivian Lee, Pomona, CA (US)

(72) Inventor: Vivian Lee, Pomona, CA (US)

(21) Appl. No.: 14/937,815

(22) Filed: Nov. 10, 2015

Related U.S. Application Data
(60) Provisional application No. 62/077,789, filed on Nov. 10, 2014.

(51) Int. Cl. A41D 13/12; A61J 15/00; A41D 27/20; A41B 9/06; A41B 1/08

(52) U.S. Cl. CPC A41D 13/1245; A41B 9/06; A41B 1/08; A41D 27/20; A61J 15/0053

(57) ABSTRACT

The invention is a soft, comfortably fitting upper body undergarment constructed for the comfort and convenience of individuals whose medical treatment or condition requires using a gastric feeding tube comprising a tubular pocket which is open at one end to accommodate a gastric tube safely, cleanly and comfortably.

### CLAIM OF PRIORITY

This patent application claims priority under 35 USC 119 (e) (1) from U.S. Provisional Patent Application Ser. No. 62/077,789 filed Nov. 10, 2014, of common inventorship herewith entitled, “Le Side Slide Pocket,” which is incorporated herein by reference as though the same were set forth in its entirety.

### FIELD OF THE INVENTION

The present invention pertains to the field of medical equipment accessories, and more specifically to the field of covering apparel for gastrointestinal feeding tubes.

### BACKGROUND OF THE INVENTION

The prior art has put forth several designs for covering apparel for gastrointestinal feeding tubes. Among these are:

US Patent 2011/0173736 to Tina McDonnell describes an elastic body suit worn on a human to protect the human or patient from having access to a gastric tube site. A gastric flap is located at the gastric tube site in the front of the structure and is securely closed by a fastener on its three open sides and a strap that runs from the front to the back of the garment. The gastric flap is opened by removing the strap from the fasteners and releasing the gastric flap from the fasteners on the structure. A second flap is located on the front at bottom of the structure. The second flap has fasteners around the three sides and is secured to the structure as part of the structure on the fourth side. The flap extends under the structure to the back of the structure.

U.S. Pat. No. 7,661,152 to Raul Manzano-Rivera describes a flexible, belt shaped garment to be used around the torso of a person who requires a gastrostomy tube to receive nourishment. The garment comprises a totally flexible main elongated body having an upper end, a lower end, a first lateral side, a second lateral side, an outer surface and an inner surface intended to be in contact with the patient's body. It also comprises an aperture or opening in cooperative action with a flap cover that creates an internal pocket when closed, wherein the gastrostomy tube is safely stored. A second mechanism for covering the internal pocket overlaps the closed cover flap with of one of the lateral sides of the main body. Optional ties or laces wrap around the installed belt and tie up for maximizing the protection of the gastrostomy tube and the stoma area.

U.S. Pat. No. 6,438,758 to Kathleen A. Burkard and Renee M. Dickersen describes a feeding tube accessible wearing apparel for giving a user a sense dignity and privacy during a medical procedure. The feeding tube accessible wearing apparel includes an upper body garment having a neck receiving opening and arm receiving openings and also having a front side with a hole being disposed through the front side. This apparel also includes a flap member being attached to the front side of said upper body garment and being coverable over the hole.

None of these prior art references describe the present invention.

### SUMMARY OF THE INVENTION

It is an object of the present invention to provide soft, comfortably fitting upper body undergarments constructed for the comfort and convenience of individuals whose medical treatment or condition requires using a gastric feeding tube.

### BRIEF DESCRIPTION OF THE DRAWINGS

FIG. 1 is a prototypical diagonal view of a free standing tee shirt embodiment of the present invention illustrating an integrated pocket sewn into an underside section of the shirt.

FIG. 2 is a prototypical diagonal view of a free standing tee shirt embodiment of the present invention illustrating how a lower portion of the shirt is lifted for easy access to the integrated pocket.

FIG. 3 is a prototypical close up view of the present invention's pocket component into which the gastric tube is inserted.

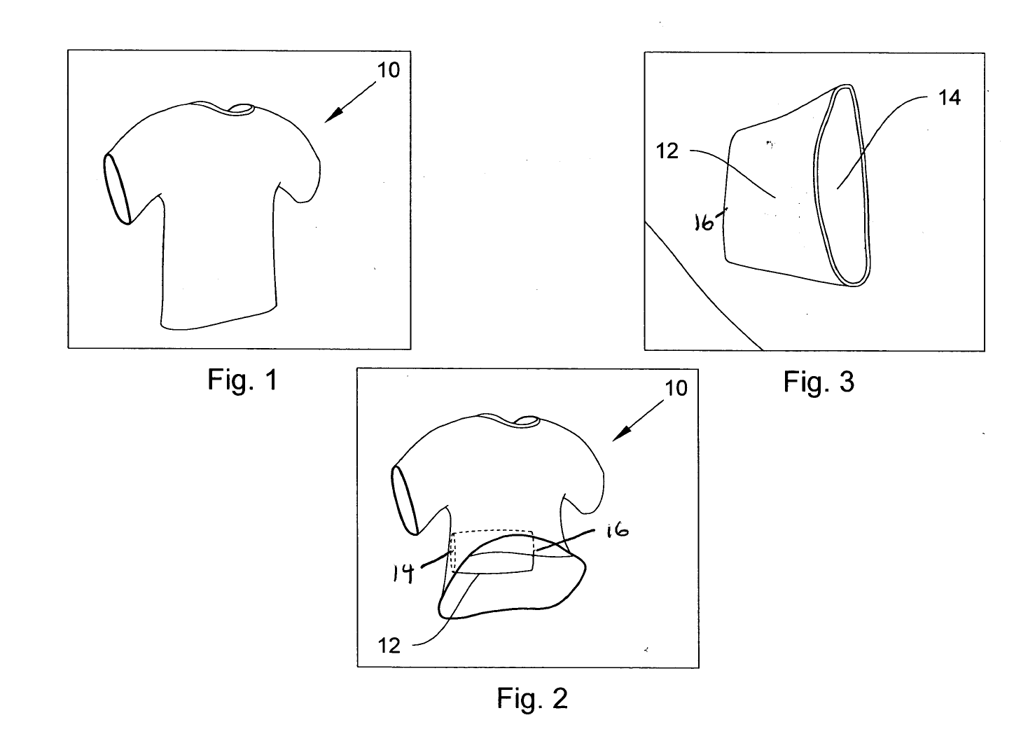

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

At some point in their lives, approximately hundreds of thousands of individuals experience medical conditions or treatments which require being fitted with a gastric feeding tube. A gastric feeding tube is a medical device inserted directly into a patient's stomach through which nutrients are passed to supplement his or her diet. Gastric feeding tubes are inserted temporarily or permanently into patients for various different reasons. This procedure is recommended for baby patients with birth defects of the mouth, esophagus or stomach, patients who are unable to swallow correctly, patients who are unable to take enough food by mouth to stay healthy, patients who often breathe in or aspirate food when eating and patients who refuse to eat. These patients may have cystic fibrosis, certain autoimmune diseases, Alzheimer's and other forms of age related dementia, and problems with malabsorption of nutrients in the digestive system.

There are two basic types of feeding tubes. A nasogastric tube or NG tube is run through the patient's nose and into his or her stomach. This sort of tube is usually used for temporary care in which the patient only requires a feeding tube for a few days. NG tubes often are very uncomfortable for patients. A gastric tube or G tube is inserted through a patient's abdominal wall with the help of an endoscope. This tube is constructed for long term use, and patients generally tape the tube to their flesh or clip it to their underclothing. This attachment method leads to problems ranging from skin irritation to unintended movements of the tube that result in pain, bleeding and infection. If the tube is simply left to hang between uses, it catches on the patient's clothing, again resulting in movement and pain and becoming visibly obvious to other people. Individuals with gastric tubes need a better, safer, cleaner, more comfortable and discreet means of managing the tube, a means of making the G tube comfortable enough that they forget about it being there.

The present invention, hereinafter referred to as the Le Side Slide Pocket or Le Pocket, is a line of soft, comfortably fitting upper body undergarments 10 constructed for the comfort and convenience of individuals whose medical treatment or condition requires using a gastric feeding tube. Please refer to the drawings. The Le Pocket line includes tee shirts and tank tops, pajama tops, dressing gowns, bed jackets, and hospital gowns. Le' Side Slide Pocket is manufactured in a variety of styles, patterns and colors. The material used to construct the garment can be cotton, cotton knit, or other fabric or fabric blend which is soft to the touch.

An open ended, slide in side pocket 12 of the Le' Pocket garments accommodates a patient's gastric tube safely, cleanly and comfortably. Le' Pocket supports and protects the gastric tube as it is worn between uses, eliminating skin irritation and concealing the tube from view. The present invention contains a soft, oblong, tubular side pocket 12 which is open at one end 14 inside the garment to receive the tube, and the other end 16 is closed or sewn into the side seam of the garment. Using a Le' Side Slide Pocket garment eliminates any use of clips or tape. Because the tube is concealed by the fabric of the Le' Pocket garment, the tube remains clean and protected from hazards such as catching on patient's clothing or bed sheets. The closed end 16 can be in the side seam of the garment, and the open end near the center of the garment. Alternatively, the closed end 16 can be near the center of the garment and the open end 14 near the side of the garment, as shown in FIG. 2.

For access to the Side Slide Pocket, the patient or caregiver simply lifts the bottom-of the tee shirt, tank top or other equipped garment. The Le' Side Slide Pocket is stitched into the underside of the garment, extending from the side hem to near the navel region. The gastric tube is simply inserted into Le' Pocket 12, and the garment is allowed to fall freely, keeping the pocket out of sight.

Patients requiring the gastric feeding tube include individuals of all ages from premature babies to very elderly individuals. By accommodating the gastric feeding tube in a concealed, supportive and comfortable sleeve type pocket, the Le' Side Slide Pocket provides tube dependent patients with a higher level of comfort and cleanliness, taking the gastric tube out of sight and out of mind. Le' Side Slide Pocket is an effectively functional invention for patients, caregivers and healthcare institutions.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A soft, comfortably fitting upper body undergarment, wherein the undergarment has side seams, and is constructed for the comfort and convenience of persons whose medical treatment or condition requires using a gastric feeding tube, comprising a tubular pocket which is open at one end to accommodate a gastric tube safely, cleanly and comfortably, and closed at the end opposite the open end.

2. The garment of claim 1 wherein the pocket is closed at the side seam of the garment, and the open end near the center of the garment.

3. The garment of claim 1 wherein, the pocket is closed near the center of the garment and the open at or near the side of the garment.

4. The garment of claim 1 wherein the pocket is stitched into the underside of the garment, extending from the side seam of the garment to near the navel region of the person.

5. The garment of claim 1, selected from the group consisting of tee shirts, tank tops, pajama tops, dressing gowns, bed jackets, and hospital gowns.

6. The garment of claim 2, selected from the group consisting of tee shirts, tank tops, pajama tops, dressing gowns, bed jackets, and hospital gowns.

7. The garment of claim 3, selected from the group consisting of tee shirts, tank tops, pajama tops, dressing gowns, bed jackets, and hospital gowns.

8. The garment of claim 1, manufactured in a variety of styles, patterns and colors.
